(19) United States
(12) Patent Application Publication
(10) Pub. No.: US 2002/0077769 A1
(43) Pub. Date: Jun. 20, 2002

(54) Method for registering the actual description of a measured object with a nominal description

(76) Inventor: Martin Ebinger, Ulm (DE)

Correspondence Address: DAVIDSON, DAVIDSON & KAPPEL, LLC, 485 SEVENTH AVENUE, 14TH FLOOR, NEW YORK, NY, 10018, US

(21) Appl. No.: 09/934,723

(22) Filed: Aug. 22, 2001

(30) Foreign Application Priority Data
Aug. 23, 2000 (DE) DE 100 41 292.0

(51) Int. Cl. G01C 19/00

(52) U.S. Cl. 702/150

(57) ABSTRACT

A method for registering the actual description MI of an object under measurement with a nominal description MS of the object under measurement in which the actual description MI describes the actual geometric dimensions, the actual position and the actual orientation of the object under measurement and in which defined geometric dimensions, a defined position and a defined orientation are described via the nominal description MS for the object under measurement. The elements of the actual description MI are measured and the elements of the nominal description MS are predefined, for example, in the form of a CAD description. According to the present invention, a transformation T for aligning the object under measurement according to its nominal description is determined in an iterative method. To this end, selected values are defined for MI and MS, which corresponds to an extraction of features from the measured data and the CAD description. Then, corresponding elements from MI and MS are either established or determined by determining the target values for the selected values. The target values extend in each case the other set.

### BACKGROUND OF THE INVENTION

The present invention relates to a method for registering the actual description MI of an object under measurement with a nominal description MS of the object under measurement in which actual description MI describes the actual geometric dimensions, the actual position and the actual orientation of the object under measurement and in which defined geometric dimensions, a defined position and a defined orientation are specified via nominal description MS for the object under measurement. The elements of actual description MI are measured and the elements of nominal description MS are predefined.

In general, a registration is used to link data which is present in different coordinate system. At this point, the setpoint/actual value comparison between CAD data and measured data should be mentioned as an example of such a linkage. The CAD data describes a design element and, consequently, represent the nominal description of a workpiece which has been manufactured on the basis of the aforementioned CAD data. The measured data represents the actual description of the manufactured workpiece which constitutes the object under measurement. The CAD data exists in the so-called “design coordinate system” whereas the measured data exists in the measuring or workpiece coordinate system. The intention is for a transformation describing the interrelationship of the involved coordinate systems to be determined with the aid of the registration.

In the following, two examples of application for a registration will be described with reference to FIGS. 1 through 4 as well as 5 and 6.

FIGS. 1 through 4 depict the preparation of a setpoint/actual value comparison by registration using subsequent transformation. FIG. 1 shows the CAD description of a turbine blade 1 featuring a base 2. Defined in the CAD description are alignment points 3 which predefine the positions which the transformation is intended to approximate the best way possible. Alignment points 3 can be allocated a weighting factor which increases or else reduces the weight of an alignment point 3. Thus, in the depicted example, at one time base 2 and, at another time, blade region 4 of turbine blade 1 can be given more weight and thus be approximated to a greater degree by the registration. In the present case, base 2, as the mounting location, is taken to be highly binding. The measured data is depicted in FIG. 2. FIG. 3 shows the measured data together with the CAD description so that the existing misorientation of the object under measurement with respect to the CAD description is clearly discernible. A direct comparison between the two data sets, namely of the nominal description in the form of the CAD description and the actual description in the form of the measured data is still not easily possible in this manner. With the aid of registration, it is now possible to find a transformation which enables such a comparison. FIG. 4 shows the situation after a suitable transformation has been applied to the measured data. This transformation yields the desired excellent correspondence in base region 2 of turbine blade 1. The here existing error of form of the object under measurement in blade region 4 can now be determined.

FIGS. 5 and 6 depict a sensor calibration and a sensor alignment by registration, respectively. FIG. 5 shows the measurement set-up for the calibration of a contour sensor 5. In lieu of a workpiece, a test means 6 is measured whose CAD description exists in the measuring coordinate system of sensor 5. The measured values of calibrated sensor 5 are intended to lie within a tolerance field on the intersection between test means 5 and the measuring plane of sensor 5 which is shown with a dotted line. If this is not the case, which is shown here with a solid line, an undefined deviation between the measured test means 6 and the CAD description of test means 6 is detected. However, since the configuration of test means 6 is known, the deviation that has arisen is attributed to the fact that sensor 5 is not calibrated any more. The relationship of the coordinate systems of test means 6 and sensor 5 is no longer known sufficiently accurately.

FIG. 6 shows how, via a registration of the measuring points onto the CAD description of test means 6, a transformation is determined which minimizes the calibration error. It is not absolutely necessary for the contour of test means 6 to be exactly fitted in because a contour error, that is a form deviation of test means 6 from its CAD description is of no importance here. In the present case, it is possible to determine a transformation which is exclusively composed of a translation and a rotation in the sensor plane. At this point, it should be mentioned that the sought transformation is generally not limited as in the example which is described here. Via the transformation, the misorientation of the sensor is determined as well. To calibrate the sensor, it is either possible to compensate for the misorientation by calculation or to realign the sensor in accordance with the ascertained transformation. The deviations between measured test means 6 and the CAD description of test means 6 represent a measure for the quality of the sensor.

In practice, for example, a so-called “coordinate measuring instrument measurement” is carried out for aligning the object under measurement. In the process, the measuring points on the basis of which the object under measurement is to be aligned are predefined by a test plan. These measuring points are derived from the appertaining reference coordinates of the CAD data. The alignment of the object under measurement is generally carried out according to the 321 method which will be described in the following:

A spatial direction is determined as the first axis of the workpiece coordinate system to be generated. Depending on the type of the workpiece, this can be the orientation of a plane which has been defined by at least three measuring points or else a cylinder axis which has been defined by n measuring points.

The second axis of the workpiece coordinate system is determined by at least two measuring points which can lie in a plane perpendicular to the first axis of the workpiece coordinate system. If necessary, the projection of the measuring points onto this plane can also be used.

Thus, the third axis of the workpiece coordinate system is determined as well because it is oriented perpendicularly to the two already determined axes.

Finally, the zero point of the workpiece coordinate system is defined as well, for example, also with the aid of a measuring point.

If the workpiece coordinate system and the design coordinate system are not identical, it can be required for the workpiece coordinate system to be transformed in an additional step to obtain the design coordinate system. To this end, it is possible, for example, to shift the zero point of the workpiece coordinate system in a predefined fixed translation.

In practice, the above-described method turns out to be relatively inflexible since, here, it is only possible to evaluate measured data which has been acquired at the measuring points specified by the test plan. Here, an alignment of the object under measurement on the basis of an overdetermined set of measured data is not possible. Besides, coordinate measuring instruments can be used in manufacturing processes only to a limited extend because of the execution time required for the alignment and the actual measurement. Thus, when working with cycle times of 5 minutes and less, 100% control can no longer be attained.

### SUMMARY OF THE INVENTION

An object of the present invention is to develop and refine a method for registering of the type mentioned at the outset in such a manner that measured data representing an overdetermined image of the object under measurement can be processed as well, and that the execution time required for determining the alignment of the object under measurement allows the method according to the present invention to be used on-line in a manufacturing process.

The present invention provides a method for registering the actual description MI of an object under measurement with a nominal description MS of the object under measurement. The actual description MI describes the actual geometric dimensions, the actual position and the actual orientation of the object under measurement, and defined geometric dimensions, a defined position and a defined orientation are specified via the a nominal description MS for the object under measurement in which the elements of the actual description MI are measured and the elements of nominal description MS are predefined. A transformation T aligning the object under measurement according to its nominal description is determined in an iterative method.

The transformation is determined using the iterative method:

(1) by determining an initial transformation Tᵢₙᵢₜ, which is used for mapping the actual description MI, resulting in a transformed actual description MIt, and by mapping the nominal description MS with the inverse Tᵢₙᵢₜ⁻ of initial transformation Tᵢₙᵢₜ, resulting in a transformed nominal description MSt,

(2) by determining target elements from nominal description MS for selected elements of transformed actual description MIt, and by determining target elements from actual description MI for selected elements of transformed nominal description MSt,

(3) in that the target elements of MIt are transformed with the inverse Tᵢₙᵢₜ⁻ and form the target elements for the selected elements of actual description MI; and in that the target elements of MSt are transformed with the initial transformation Tᵢₙᵢₜ, and form the target elements for the selected elements of nominal description MS,

(4) in that, for determining the quality of transformation Tᵢₙᵢₜ, both a scalar clamping error is determined from the determined selected elements of transformed actual description MIt and corresponding target elements of nominal description MS, and a scalar clamping error is determined from the determined selected elements of actual description MI and corresponding target elements of transformed nominal description MSt,

(5) by modifying transformation Tᵢₙᵢₜ as a function of its quality in an exploratory method, and by proceeding with the modified transformation according to steps (1) through (5) until a termination criterion for the exploration is reached.

The method according to the present invention is considerably less sensitive with respect to measured-value acquisition than the coordinate measuring instrument measurements known from practice for which the measured-value acquisition must take place at measuring points which are predefined by a test plan. In contrast, the method according to the present invention permits the processing of measured data which represents an overdetermined image of the object under measurement. According to the present invention, in fact, the elements of the actual description which best correspond to the elements of the nominal description are determined from this measured data, which will be described in detail within the scope of a detailed explanation of the method according to the present invention. Thus, measured values from 1D, 2D and 3D sensors can be used jointly within the scope of the method according to the present invention. In this context, it is possible to use sensors having different functional principles as, for example, sensors working in a tactile, inductive, or optical manner. The method according to the present invention can be flexibly and individually configured by suitable selections or inputs according to the specific purpose of use, which is additionally promoted by a modular design of the method according to the present invention. Moreover, the modules of the method according to the present invention can be used individually or also in combination for solving further metrological problems such as in quality assurance, sensor testing or sensor calibration.

As a general principle, the teaching of the present invention can be implemented and advantageously refined in different way as described for example in the dependent claims.

### BRIEF DESCRIPTION OF THE DRAWINGS

The following detailed explanation of a preferred method according to the present invention is explained with reference to the following drawings, in which:

FIGS. 1 through 4 show the preparation of a setpoint/actual value comparison by registration with subsequent transformation (as discussed above).

FIGS. 5 and 6 depict a sensor calibration and a sensor alignment by registration, respectively, (as discussed above).

FIGS. 7 through 11 show a method for determining a clamping error as a measure for the deviation of the actual description of an object under measurement from its nominal description.

FIGS. 12 through 14 show a method for determining corresponding elements, in particular spatial points, in two descriptions of an object under measurement.

FIGS. 15 through 20 show a method for determining a transformation for aligning an object under measurement according to its nominal description.

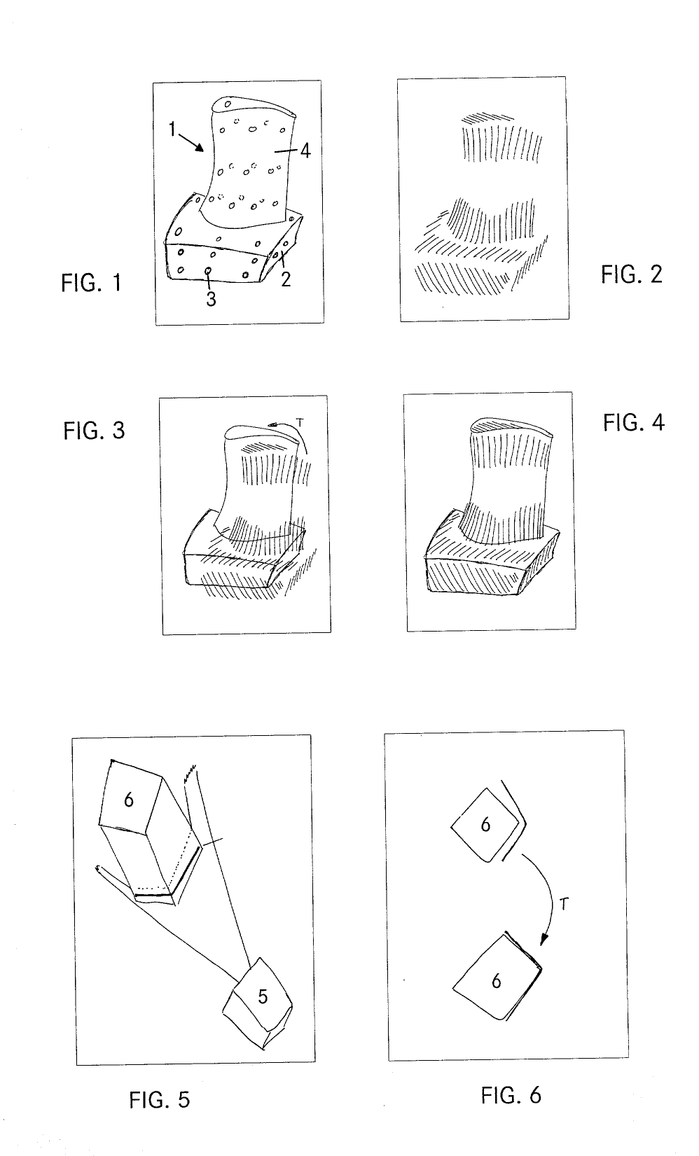

### DETAILED DESCRIPTION

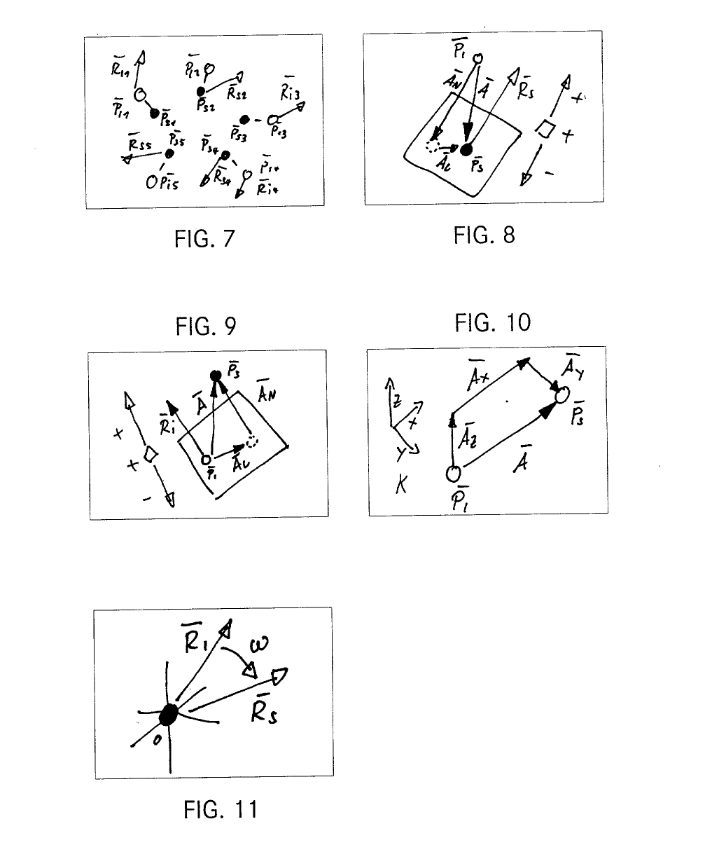

Initially, for easier understanding of the method according to the present invention, the determination of a scalar clamping error as it is determined in step (4) of the method according to the present invention will be explained in the following with reference to FIGS. 7 through 11. The clamping error is a measure for the deviation of the actual description of an object under measurement from its nominal description, that is a measure for the misorientation of an object under measurement with respect to its nominal description.

The clamping error is determined on the basis of:

nominal description MS of the object under measurement, that is a shape description of the object under measurement in its correct clamping position, the nominal description existing in the form of points in space, it being possible for each point to be allocated a direction in space,

actual description MI of the object under measurement, that is the description of the actual clamping position of the object under measurement, the actual description existing in the form of points in space, it being possible for each point to be allocated a direction in space,

a clear correlation between the points of the nominal description and the points of the actual description,

a rule for conditioning the measured data (constraint error measure determination), namely for determining the error measure for each pair of corresponding points of the nominal description and actual description,

a rule for bringing together the error measures determined for each pair of corresponding points of the nominal description and actual description (constraint clamping error determination).

Actual description MI includes features which are obtained from the totality of measured data. These features can be determined automatically or interactively by the user (selected values). They can also be automatically generated as target values for MS during the fitting-in, which will still be explained in greater detail in the following. The elements of actual description MI can describe, for example, single measuring points, measuring points averaged by modeling, center points of circles and spheres, circle or cylinder axes, the orientation of a plane, etc. In this context, geometric elements such as plane, circle, etc. are fitted into the set of measuring points in that they constitute a description of the measuring points which is reduced in data and generally afflicted with less noise as well. Besides, it is possible to form further geometric elements for the measured data without these geometric elements being elements of actual description MI. Geometric elements can also be derived from measured data on measuring aids. Measuring aids are, for example, pins inserted into bore holes, balls inserted into punched openings, or also clamping devices, etc.

Analogously, nominal description MS can include features such as single points on CAD description, axes of cylinders etc., center points of circles or spheres etc. with or without indication of direction. On the basis of the existing design, new or altered elements can be generated and used here as “aids”. Nominal description MS contains selected values and target values for MI. The target values extend in each case the other set, that is the target values for MI extend nominal description MS such as the target values for MS extend actual description MI.

Advantageously selected as spatial points Pₛᵢ of nominal description MS are points which each lie in one of the defined surfaces of the object under measurement. These spatial points Pₛᵢ can then be allocated in each case the normal to the corresponding defined surface of the object under measurement in spatial point Pₛᵢ as spatial directions Rₛᵢ. Correspondingly, it is advantageous if points in one of the surfaces of the object under measurement are determined as spatial points P₁ᵢ of actual description MI. These spatial points P₁ᵢ are then allocated in each case the normal to the corresponding defined surface of the object under measurement in spatial point P₁ᵢ as spatial directions Rₕ.

At this point, it should be mentioned that spatial points Pₛᵢ of nominal description MS and spatial points P₁ᵢ of the actual description can be allocated feature elements alternatively or also in addition to spatial directions. Here, possible geometrical feature elements include a circle, a cylinder, or a sphere, which represent the configuration of the object under measurement in specific regions.

FIG. 7 depicts nominal description MS of an object under measurement with corresponding actual description MI of the object under measurement. Here, nominal description MS is composed of spatial points Pₛᵢ and spatial directions Rₛᵢ. The actual description is composed of spatial points P₁ᵢ and spatial directions R₁ᵢ.

Scalar clamping error F of this overall configuration is led back to the determination of an error measure Fᵢ for each pair of corresponding points from nominal description MS and actual description MI. FIGS. 8 through 11 show the different ways of determining the error measure, depending on the availability of directional information on spatial points Pₛᵢ and P₁ᵢ.

In FIG. 8, spatial point Pₛ of nominal description MS is allocated spatial direction Rₛ while no spatial direction is allocated to corresponding spatial point P₁ of actual description MI. Vectorial difference A in the X, Y and Z directions is now determined as shown. Via directional information Rₛ, it is also possible to break down vectorial difference A into a vector component AN perpendicular to the plane given by spatial point Pₛ, and spatial direction Rₛ and into a vector component AL within this plane. For the constellation shown in FIG. 8, it is thus possible for vectorial difference A to be described in vector components AX, AY, and AZ.

In the case of the situation shown in FIG. 9, spatial point P₁ of actual description MI is allocated spatial direction R₁ while no spatial direction is allocated to corresponding spatial point Pₛ of nominal description MS. Here, vectorial difference A can analogously be described in vector components AX, AY, and AZ or in vector components AN and AL, AN representing the vector component of vectorial difference A perpendicular to the plane given by spatial point P₁ and spatial direction R₁, and AL representing the vector component of vectorial difference A within this plane.

If no spatial direction is available for any of spatial points Pₛ and P₁, as is shown in FIG. 10, then vectorial difference A is represented in its vector components AX, AY, and AZ with a given coordinate system K. Via a combination of AX, AY, or AZ, it is thus possible to specify the difference in one of the main planes of coordinate system KXY, KYZ, and KXZ, or the difference along one of axes KX, KY, or KZ of the coordinate system.

If both of spatial points Pₛ and P₁ are allocated a spacial direction Rₛ, and R₁, then vectorial difference A can be determined either as described in connection with FIG. 8 or as described in connection with FIG. 9. In this case, moreover, an angle error w can be determined as shown in FIG. 11.

A scalar error measure for the mutually corresponding spatial points Pₛ and P₁ is determined from vector components AX, AY, AZ, AL and/or AN and from angle error w. This error measure includes a distance component and, possibly, an angle component. Both the distance component and the angle component can be weighted with a weighting factor Ga or Gw, respectively, prior to adding up these two components. Selected as distance component is a vector component AX, AY, AZ, AN, or AL, or a combination of several of these vector components. Resulting therefrom by vectorial addition is a differential vector D which is representative of the distance error and whose length is determined as distance component of the scalar error measure. If a spatial direction was available during the determination of vector components AX, AY, AZ, AL and AN, then the distance component of the scalar error measure can also be allocated a plus or minus sign. The sign is determined in accordance with FIGS. 8 or 9. The spatial point, which is allocated a spatial direction, defines a plane in conjunction with this spatial direction. If the spatial point corresponding to this spatial point lies above or within this plane, then the distance component is allocated a positive sign +1. In the other case, the sign of the distance component is negative, −1. Angle error w (See FIG. 11), as a scalar value, constitutes the angle component of the scalar error measure without further transformation.

The error measure determination for a pair of corresponding spatial points of the nominal description and the actual description of an object under measurement can thus be summarized as follows:

Given are:

1. a spatial point Pₛᵢ of the nominal description and, possibly, a spatial direction Rₛᵢ allocated to this spatial point Pₛᵢ (spatial direction Rₛᵢ can also be absent),

2. a spatial point P₁ᵢ of the actual description corresponding to spatial point Pₛᵢ of the nominal description and, possibly, a spatial direction R₁ᵢ allocated to this spatial point P₁ᵢ (spatial direction R₁ᵢ can also be absent),

3. information on which of vector components AXᵢ, AYᵢ, AZᵢ, ANᵢ, ALᵢ is intended to form differential vector Dᵢ,

4. weighting factors Gaᵢ for the distance error and Gwᵢ for the angle error,

5. tolerance fields for the distance error and the angle error.

The required error measure for the pair Pₛᵢ, P₁ᵢ is then determined as

Fᵢ=Gaᵢ·length(Dᵢ)+Gwᵢ ·wᵢ

If it is not possible for the initial data specified under 1. and 2. to be processed with the calculation rules specified under 3. and 4., then an error measure

Fᵢ=0

is specified.

If length(Dᵢ) lies outside of the tolerance field for the distance mentioned under point 5., then the distance component is ignored and the error measure is determined as

Fᵢ=Gwᵢ ·wᵢ

If wᵢ lies outside of the tolerance field for the angle mentioned under point 5., then the angle component is ignored and the error measure is determined as

Fᵢ=Gaᵢ ·length(Dᵢ)

If both length(Dᵢ) and wᵢ lie outside of the tolerance fields mentioned under point 5., then the error measure is determined as

Fᵢ=0

As already mentioned, scalar clamping error F of the overall configuration, that is between the nominal description and the actual description of an object under measurement altogether, is led back to the determination of an error measure Fᵢ for each pair of corresponding points from nominal description MS and actual description MI. To determine scalar clamping error F, all error measures Fᵢ are brought together. There are, inter alia, the following ways to do this:

The mean square deviation from scalar clamping errors Fᵢ related to the expected value zero, the smallest possible error measure for a pair of corresponding spatial points

F=SQRT(SUM(1, n, Gaᵢ·length(Dᵢ)·length(Dᵢ)+Gwᵢ·wᵢ·wᵢ)))/SUM(1,n,(Gaᵢ+Gwᵢ))

where n is the number of pairs for which a clamping error Fᵢ could be determined.

The mean deviation from the absolute values of scalar clamping errors Fᵢ

F=SUM(1, n, (ABSOLUTE VALUE(Gaᵢ·length(Dᵢ))+ABSOLUTE VALUE(Gwᵢ·wᵢ)))/SUM(1,n,(Gaᵢ,+Gwᵢ))

where n is the number of pairs for which a clamping error Fᵢ could be determined.

The maximum deviation from the absolute values of scalar clamping errors Fᵢ

F=MAXIMUM(ABSOLUTE VALUE(F₁),(ABSOLUTE VALUE(F₂), . . . ,(ABSOLUTE VALUE(Fₙ )

The maximum positive deviation of scalar clamping errors Fᵢ

F=MAXIMUM(F₁, F₂, . . . ,Fₙ)

The maximum negative deviation of scalar clamping errors Fᵢ

F=MINIM(F₁, F₂, . . . , Fₙ),

where n is in each case the number of pairs for which a clamping error Fᵢ could be determined.

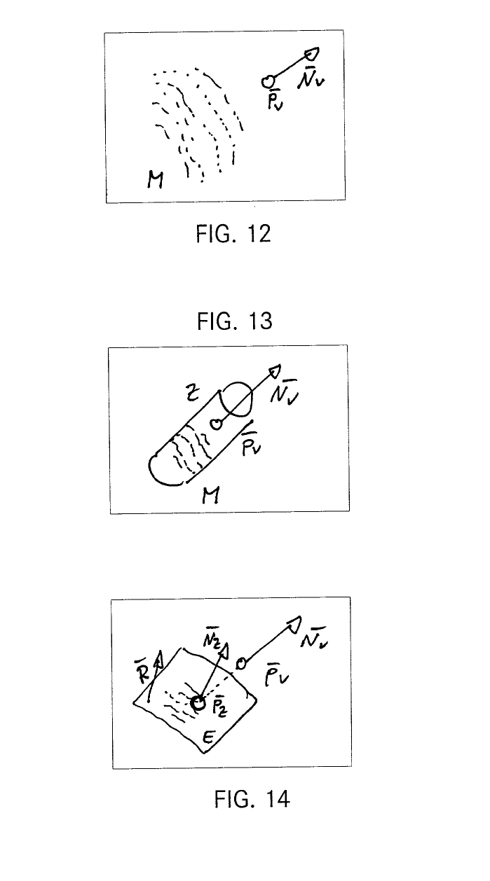

On the basis of FIGS. 12 through 14, a method for determining corresponding elements, in particular corresponding spatial points, in two descriptions of an object under measurement will now be explained as is used in step (2) of the method according to the present invention. The goal is the determination of pairs for which a clamping error can be determined as explained above. The determination of pairs is carried out in several steps and can start from each of the two descriptions of the object under measurement. To this end, elements of one of the two descriptions are selected in advance as selected elements.

Sets MI and MS are allocated selected values. The manners of procedure of the method for determining corresponding elements, which will be explained in greater detail in the following, serves also for the interactive generation of the selected values for MI and MS by the user. Generally, no links exist yet between the selected values of MI and MS. A pair which can be already derived here, for example fitted-in cylinder against designed cylinder, can be established by the user. If enough such predefined pairs exist, then it is possible for the initial transformation to be determined automatically. These selected values of sets MI and MS clearly show where the fitting-in will be carried out or on the basis of which data set an error measure determination will be carried out.

During the determination of the registration transformation, the corresponding target values for the selected values are determined as far as this is possible. The target values are allocated to the in each case other set so that they extend this set. Pairs form MI and MS are built up.

MI and MS constitute a data concentration of the measurement or nominal description, respectively. This limitation to the essential part finally results in the advantages according to the present invention:

reliable handling of this registration method,

fast determination of the transformation or of the clamping error;

generation of the selected values on the basis of the, in each case, more suitable data set, nominal or actual, combined with the automatic breaking up of the correspondence,

noise reduction via the fitting-in of geometric elements,

noise reduction by modeling.

The basis for the determination of pairs are:

the indication of selected elements,

the indication of control parameters which permit the determination of an individual subset of the target set for each selected element,

information on the object description (data set)

general measured values.

feature elements, circle, cylinder . . .

CAD description

etc.

The target set for MI is composed of:

all design elements of the CAD description,

arbitrary features extracted from the CAD description,

elements which are newly designed or altered on the basis of the CAD description, in particular of elements of set MS.

The target set for MS includes:

all measured data,

all geometric elements such as circle, etc., which are extracted from the measured data, also from the measuring aids,

also the elements from MI.

For the determination of pairs, a subset of the target set is determined on the basis of a selected element. The subset of the target set can include, for example, one or several spatial points, a surface description, or also a feature element. By fitting in geometric objects such as a cylinder, a plane, a sphere, or a circle, which represent a model of the object under measurement in the region of the subset, it is possible to further restrict the subset for determining the target element. In this manner, it is possible to determine corresponding elements of two descriptions of the object under measurement even if the descriptions are overdetermined.

The selection function with the aid of which a subset of the target set is determined, and the scanning function which is used to determine the point and direction of the target value from the subset, can be individually adjusted for each selected value. In particular, as already mentioned, the automatic, controlled fitting-in of geometric elements onto measured data or the design can be initiated by the method for determining corresponding elements.

The selection functions from the target sets permit:

the selection of a subset by specifying the target space,

und/or the selection of a subset by specifying the target type such as axis, point, surface, measuring points, etc.,

und/or the selection by specifying features such as name, color of the visualization,

the fixed allocation of a geometric element,

the fixed allocation of a selected element, of course none from the same set,

no allocation, that is the error zero is always determined for a non-evaluable element of the selected set.

The scanning functions from the subsets yield, inter alia:

the point and/or direction of selected geometric elements, the geometric elements being fixed,

the point and/or direction of automatically fitted-in geometric elements, the fitting-in being automatically repeated during the determination of the transformation,

the projection point from modeling and projection of the transformed selected value as well as the projection direction from the selection input and/or model,

the measuring point lying closest,

etc.

The now possible fixed correlation of nominal-actual pairs permits the automatic determination of a pre-orientation Tᵢₙᵢₜ. This fixed correlation also allows axes, straight lines, normals, etc. to be paired without taking a location into account. Formerly, the indication of a location was mandatory for the scanning. In this manner, it is possible to define pairs which exclusively describe an angle error. This enables the alignment with respect to conditions such as “is parallel to”, is perpendicular to”, etc.

This purely mathematical scanning of the measured point data and determination of the selected values of MI can be mapped onto tactile coordinate metrology without difficulty. In this context, the digitalization of measuring elements as, for example, point, sphere, cylinder, etc., corresponds to the determination of a selected value for MI. The determination of a target value for MS corresponds to the automatic point or feature measurement.

In the exemplary embodiment depicted in FIGS. 12 through 14, a spatial point Pᵥ was selected as a selected value. Spatial point Pᵥ is allocated a spatial direction Nᵥ which, however, does not have to be always the case. FIG. 12 shows a set of points M which constitutes the target set for spatial point Pᵥ. A target element corresponding to spatial point Pᵥ is now to be determined from this target set M. The target element is also intended to be a spatial point which can possibly be allocated a direction in space.

Via a control parameter allocated to the selected element, a subset is determined from target set M, the intention being for the subset to satisfy the further criteria as, for example, that the subset has to lie within a specific volume or to satisfy a measure of quality. In the exemplary embodiment described here, the control parameter allocated to spatial point Pᵥ is a specified volume, namely information on the form and position of a search cylinder Z relative to spatial point Pᵥ. FIG. 13 shows the restriction of target set M depicted in FIG. 12 via search cylinder Z.

The target element is now determined from the subset. If the selected element possesses a direction, as in the case which is described here, then this direction can be included in the determination of the target element. To this end, here, a plane E is fitted into the region of search cylinder Z as a model of the object under measurement in an intermediate step. Determined as the target element is the projection of the selected element, of spatial point Pᵥ, along the allocated spatial direction Nᵥ onto plane E, or the point of target set M which lies closest to this projection. Moreover, the target element is allocated the orientation of plane E as spatial direction.

FIG. 14 shows the projection of spatial point Pᵥ onto plane E, a modeling of the subset defined by search cylinder Z, along spatial direction Nᵥ. Here, the projection point constitutes the required target element, spatial point P_{z}, and plane orientation R is allocated to spatial point P_{z} as spatial direction N_{z}. Alternatively, the base point of the perpendicular line, namely the projection of the selected element, spatial point Pᵥ, along plane orientation R onto plane can be determined as target element. If no spatial direction was allocated to the selected element Pᵥ, but a spatial direction N_{z} was determined in connection with the target element, then the selected element Pᵥ can be allocated N_{z} as the new spatial direction.

At this point, however, it should be clearly pointed out that both the target set and a suitable subset of the target set and a target element from the subset of the target set can also be determined in a different way than it is explained in the above exemplary embodiment. Within the scope of the method according to the present invention, it is possible to put together a suitable selection chain for each combination of selected element and target element.

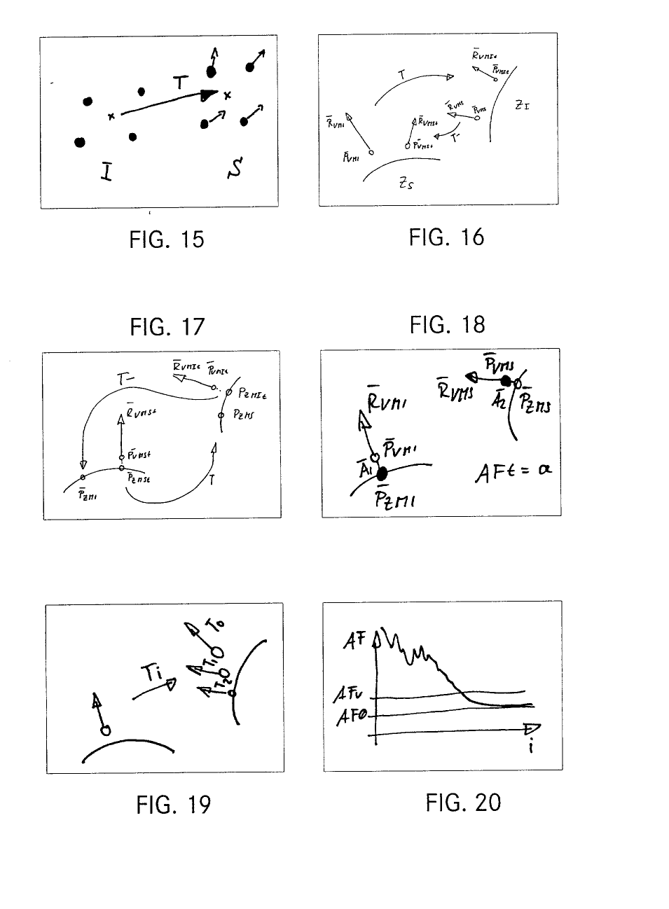

A method for determining a transformation for aligning an object under measurement according to its nominal description will now also be explained with reference to FIGS. 15 through 20. Used within the scope of the determination of such a transformation are both the method for determining a clamping error described in connection with FIGS. 7 through 11 and the method for determining corresponding elements of two descriptions illustrated in connection with FIGS. 12 through 14.

In the determination of a transformation for aligning an object under measurement, the intention is to correct the position error, the tilt error as well as the scaling error.

The method is based on:

selected elements of actual description MI of the object under measurement,

selected elements of nominal description MS of the object under measurement,

all selections of the above-described method for determining the clamping error,

all selections of the above-described method for determining pairs for MI and MS,

the specification of all components of the clamping error which are to be corrected (constraint alignment). These are, inter alia, translation, rotation, and scaling in X-, Y- and Z-direction,

limit values and termination criteria for the exploration of the transformation.

In a first step, an initial transformation Tᵢₙᵢₜ is determined. If parameters of the required transformation can directly be determined from the selected elements of nominal description MS and of actual description MI, it is possible to initialize selected parameters. Otherwise, the unit matrix is specified for Tᵢₙᵢₜ. In FIG. 15, it is depicted, for example, how the translatory component of the required transformation is approximated from the centroids of the selected elements of nominal description MS and of actual description MI. However, a translation and/or a rotation between corresponding feature elements of actual description MI and of nominal description MS could also be determined as the initial transformation Tᵢₙᵢₜ.

In a second step, the selected elements of nominal description MS are oriented as the target set with respect to actual description MI via the inverse Tᵢₙᵢₜ of initial transformation Tᵢₙᵢₜ, and the selected elements of actual description MI are oriented as the target set with respect to nominal description MS via initial transformation Tᵢₙᵢₜ. The application of these transformations to nominal description MS and actual description MI results in transforms MSt and MIt, respectively. FIG. 16 shows the orientation of the selected elements of nominal description MS and actual description MI via Tᵢₙᵢₜ.

At this point, first of all, the target elements for the selected elements of transformed nominal description MSt are determined from actual description MI and, secondly, the target elements for the selected elements of transformed actual description MIt are determined from nominal description MS, using the method for determining pairs which is described above in detail. If no sufficient quantity of pairs can be generated, the alignment fails, that is transformation Tᵢₙᵢₜ has turned out to be unsuitable. In this case, the method for registering is to be preceded by a pre-alignment, which can be carried out, for example, interactively by the user. Mostly, an initial transformation can be definitely preset.

The found target elements are now retransferred to nominal description MS and actual description MI. The target elements of MSt are transformed with Tᵢₙᵢₜ and form the target elements for the elements of nominal description MS. Correspondingly, the target elements of MIt are transformed with Tᵢₙᵢₜ and form the target elements for the elements of actual description MI. Thus, the result reflects the situation subsequent to the application of Tᵢₙᵢₜ. FIG. 17 shows the pairs found within the scope of the determination of pairs from nominal description MS and actual description MI, making allowance for transformation Tᵢₙᵢₜ.

By determining a scalar clamping error AFt, the result of transformation Tᵢₙᵢₜ is weighted, which is shown in FIG. 18. Thus, clamping error Aft describes the quality of transformation Tᵢₙᵢₜ.

According to the present invention, initial transformation Tᵢₙᵢₜ is now modified using an exploratory method such as interval halving, gradient analysis, or Newtonian method for zero point determination, which is depicted in FIG. 19. With this modified transformation it is proceeded as with transformation Tᵢₙᵢₜ. Thus, again, the modified transformation is weighted and, possibly, further modified.

This is repeated until a criterion for terminating the exploration is fulfilled. The exploration approximates clamping error AFt asymptotically to a limit value AF0. This limit value corresponds to the best possible alignment is not known beforehand. In theory, the limit value can be 0, which corresponds to a perfect, error-free alignment. Possible criteria for termination further include:

a preset maximum number of modifications,

the clamping error cannot be further improved or reduced,

the clamping error is already smaller than a selected value AFv,

etc.

FIG. 20 shows the approximation of AFt to AF0. A possible selected value AFv is shown as well.

During the iterative search for the best fitting-in, the method which will be explained in the following turns out to be advantageous, using the Fourier analysis. Initially, parameter A to be optimized of the required transformation is varied in the vicinity of its current value in a suitable manner. As a result, one obtains a set X of parameter values. The error measures are determined for the elements of X, forming a set F(X). The range of numbers defined by X is mapped in [−π. . . +π], which is achieved by linear function G. Then, the pairs of values (G(x),F(x)) x from set X are subjected to a Fourier analysis to determine phase angle w of the fundamental wave. Phase angle w defines the location at which scanned error measure F(x) becomes minimal. The inverse function of G, G⁻, maps the found phase value into the domain of definition of the explored parameter. In an iteration step, the method is sequentially applied to all parameters to be optimized. The iteration steps are carried out until a termination criterion is fulfilled.

This method presents the advantage that the new measured value is directly generated from a small number of scans of the error function. In comparison with the method which is based on interval halving, the number of time-consuming evaluations of the error function is reduced. Moreover, the approximation of the error function with trigonometric functions maps the behavior of the error function in an optimum manner. Finally, it is an advantage that only one spectral line of the Fourier analysis has to be determined of which only the phase is relevant.

Thus, a measure for the dependency of the error function on the variation of a parameter has been introduced with which it can be determined whether transformation parameters are sufficiently established by the selections or inputs.

Clamping error as defined herein also includes a spreading, stretching, mounting or fixing error.

What is claimed is:

1. A method for registering the actual description MI of an object under measurement with a nominal description MS of the object under measurement, the actual description MI describing the actual geometric dimensions, the actual position and the actual orientation of the object under measurement, and defined geometric dimensions, a defined position and a defined orientation being specified via the a nominal description MS for the object under measurement, comprising the steps of:
measuring elements of the actual description MI, with elements of the nominal description MS being predefined, and
determining a transformation T for aligning the object under measurement according to the nominal description, the determining of the transformation including:
1. determining an initial transformation Tᵢₙᵢₜ for mapping the actual description MI, so as to define a transformed actual description MIt, and mapping the nominal description MS with the inverse Tᵢₙᵢₜ⁻ of initial transformation Tᵢₙᵢₜ, so as to define a transformed nominal description MSt,
2. determining target elements from the nominal description MS for selected elements of the transformed actual description MIt, and determining target elements from the actual description MI for selected elements of the transformed nominal description MSt,
3. that the target elements of MIt are transformed with the inverse Tᵢₙᵢₜ⁻ and form the target elements for the selected elements of the actual description MI; and in that the target elements of MSt are transformed with the initial transformation Tᵢₙᵢₜ and form the target elements for the selected elements of the nominal description MS,
4. that, for determining the quality of the transformation Tᵢₙᵢₜ, both a scalar clamping error is determined from the determined selected elements of the transformed actual description MIt and corresponding target elements of the nominal description MS, and a scalar clamping error is determined from the determined selected elements of the actual description MI and corresponding target elements of the transformed nominal description MSt,
5. by modifying the transformation Tᵢₙᵢₜ as a function of its quality in an exploratory method, and by proceeding with the modified transformation according to steps (1) through (5) until a termination criterion for the exploratory method is reached.

2. The method as recited in claim 1,
wherein spatial points Pₛᵢ are selected as elements of the nominal description MS and spatial points P₁ᵢ are selected as elements of the actual description MI.

3. The method as recited in claim 2,
wherein at least one of the specified spatial points Pₛᵢ of the nominal description MS is allocated a specified spatial direction Rₛᵢ so that the nominal description MS includes a spatial direction Rₛᵢ at least for one spatial point Pₛᵢ.

4. The method as recited in claim 2,
wherein a spatial direction R₁ᵢ is determined for at least one of the determined spatial points P₁ᵢ of the actual description MI so that the actual description MI includes a spatial direction R₁ᵢ at least for one spatial point P₁ᵢ.

5. The method as recited in claim 3,
wherein at least one spatial point Pₛᵢ of the nominal description MS lies in one of the defined surfaces of the object under measurement; and this spatial point Pₛᵢ is allocated the normal to the defined surface of the object under measurement in the spatial point Pₛᵢ as spatial direction Rₛᵢ.

6. The method as recited in claim 3,
wherein at least one spatial point P₁ᵢ of the actual description MI lies in one of the determined surfaces of the object under measurement; and this spatial point P₁ᵢ is allocated the normal to the determined surface of the object under measurement in the spatial point P₁ᵢ as spatial direction R₁ᵢ.

7. The method as recited in claim 2,
wherein at least one of the specified spatial points Pₛᵢ of the nominal description MS is allocated at least one feature element so that the nominal description MS includes a feature element at least for one spatial point Pₛᵢ.

8. The method as recited in claim 2,
wherein at least one feature element is determined for at least one of the determined spatial points P₁ᵢ of the actual description MI so that the actual description MI includes a feature element at least for one spatial point P₁ᵢ.

9. The method as recited in claim 8,
wherein the feature element is a geometric feature element.

10. The method as recited in claim 9 wherein the geometric feature element is a circle, a cylinder, a sphere, or a plane.

11. The method as recited in claim 1,
wherein a unit matrix is specified as initial transformation Tᵢₙᵢₜ.

12. The method as recited in claim 1,
wherein the initial transformation Tᵢₙᵢₜ is determined automatically on the basis of predefined pairs of corresponding elements of the nominal description MS and the actual description MI.

13. The method as recited in claim 2,
wherein a nominal centroid Sₛ is determined from specified spatial points Pₛᵢ of the nominal description MS; a actual centroid S₁ is determined from the determined spatial points P₁ᵢ of the actual description MI; and a translation of the actual centroid S₁ onto the nominal centroid Sₛ is determined as the initial transformation Tᵢₙᵢₜ.

14. The method as recited in claim 7,
wherein a translation or a rotation between corresponding feature elements of the actual description MI and the nominal description MS are determined as the initial transformation Tᵢₙᵢₜ.

15. The method as recited in claim 1,
wherein
initially, for determining corresponding elements of two descriptions of the object under measurement, elements of one of the two descriptions are selected which constitute the selected elements while the elements of the other description constitute the target set,
each selected element is allocated at least one control parameter with the aid of which an individual subset of the target set is determined for each selected element,
for each selected element, a target element is determined from the previously determined individual subset of the target set on the basis of additional information on the geometric configuration of the object under measurement.

16. The method as recited in claim 15,
wherein the control parameter is used to describe the shape of a search volume and its position relative to the selected element; and the elements of the target set which are contained within the search volume constitute the required subset of the target set.

17. The method as recited in claim 16,
wherein a cylinder, a sphere, or a cube are selected as the search volume.

18. The method as recited in claim 15,
wherein the additional information on the geometric configuration of the object under measurement exists in the form of a CAD description or in the form of feature information.

19. The method as recited in claims 15,
wherein
the selected element is a spatial point Pᵥ,
the target set is a set of points,
the spatial point Pᵥ is allocated a search volume as control parameter,
the points of the target set which lie within the search volume are determined as the individual subset of the target set for the spatial point Pᵥ,
the target element, spatial point P_{z}, of the spatial point Pᵥ is determined from the points of the individual subset in that a surface is fitted into the points of the individual subset as a model of the object under measurement.

20. The method as recited in claim 19,
wherein the spatial point Pᵥ is allocated a spatial direction Nᵥ, and target element P_{z} is determined as the point of the subset which lies closest to the projection of the spatial point Pᵥ along the spatial direction Nᵥ onto the plane.

21. The method as recited in claim 19,
wherein a plane E is selected in the search volume as a model of the object under measurement.

22. The method as recited in claim 21,
wherein the target element P_{z} is allocated the orientation R of the plane E as spatial direction N_{z} or, in general, each usable directional information which can be derived from the subset of the target set.

23. The method as recited in claim 18,
wherein the target element P_{z} is allocated a directional information which is derived from the subset of the target set.

24. The method as recited in claim 20,
wherein the target element P_{z} is determined as the point of the subset which is closest to the base point of the perpendicular line of the spatial point Pᵥ onto the plane E.

25. The method as recited in claim 20,
wherein the spatial point Pᵥ is allocated the spatial direction N_{z} if no spatial direction was allocated to the spatial point Pᵥ.

26. The method as recited in claim 2,
wherein the scalar clamping error F between two descriptions of the object under measurement is determined by
1. determining a vectorial difference Aᵢ for each pair of corresponding spatial points,
2. selecting at least one vector component of the vectorial difference Aᵢ as representative differential vector Dᵢ and
3. determining the length of the differential vector Dᵢ as the scalar distance error for the respective pair of corresponding spatial points.

27. The method as recited in claim 26,
wherein the distance error determined for each pair of corresponding spatial points is weighted with a weighting factor Gaᵢ.

28. The method as recited in claim 26,
wherein, given a coordinate system K, the vectorial difference Aᵢ is expressed in the vector components which lie in one of the main planes of the coordinate system KXY, KYZ, and KXZ and/or along one of the axes KX, KY, and KZ of the coordinate system.

29. The method as recited in claim 26,
the spatial points of at least one of the two descriptions being allocated spatial directions,
wherein the vectorial differences Aᵢ between the pairs of corresponding spatial points are each expressed
1. in a vector component ANᵢ perpendicular to the plane which is defined by the corresponding spatial point and the spatial direction allocated thereto,
2. and in a vector component ALᵢ lying within this plane.

30. The method as recited in claim 29,
wherein the vectorial difference Aᵢ is allocated a positive sign, +1, if the spatial point corresponding to the spatial point which defines the plane lies above this plane, and a negative sign,−1, if the spatial point corresponding to the spatial point which defines the plane lies underneath this plane.

31. The method as recited in claim 26, wherein
the spatial points of both description are allocated spatial directions,
wherein an angle error wᵢ is determined for each pair of corresponding spatial points.

32. The method as recited in claim 31,
wherein the angle error wᵢ is weighted with a weighting factor Gwᵢ.

33. The method as recited in claim 27,
wherein the scalar clamping error Fᵢ for a pair of corresponding points is determined as
Fᵢ=Gaᵢ·length(Dᵢ)+Gwᵢ·wᵢ

34. The method as recited in claim 2,
wherein the scalar clamping error Fᵢ between a pair of corresponding spatial points of two descriptions of the object under measurement is assumed to be zero (Fᵢ=0) if
1. the vectorial difference Aᵢ for this pair of corresponding spatial points cannot be determined, or
2. if no vector component of the vectorial difference Aᵢ can be selected as representative differential vector Dᵢ or
3. if the length of the differential vector Dᵢ cannot be determined as scalar distance error.

35. The method as recited in claim 26,
wherein the scalar clamping error F between two descriptions of the object under measurement is determined as the mean square deviation from the scalar clamping errors Fᵢ related to the expected value zero, the smallest possible error measure for a pair of corresponding spatial points
F=SQRT(SUM(1, n, Gaᵢ·length(Dᵢ)·length(Dᵢ)+Gwᵢ·wᵢ·wᵢ)))/ SUM(1,n,(Gaᵢ+Gw₁))
where n is the number of pairs for which a clamping error Fᵢ could be determined.

36. The method as recited in claim 26,
wherein the scalar clamping error F between two descriptions of the object under measurement is determined as the mean deviation from the absolute values of the scalar clamping errors Fᵢ
F=SUM(1, n, (ABSOLUTE VALUE(Gaᵢ·length(Dᵢ))+ABSOLUTE VALUE(Gwᵢ·wᵢ)))/SUM(1,n,(Gaᵢ+Gwᵢ))
where n is the number of pairs for which a clamping error Fᵢ could be determined.

37. The method as recited in claim 26,
wherein the scalar clamping error F between two descriptions of the object under measurement is determined as the maximum deviation from the absolute values of the scalar clamping errors Fᵢ
F=MAXIMUM(ABSOLUTE VALUE(F₁), (ABSOLUTE VALUE (F₂), . . . (ABSOLUTE VALUE(Fₙ)
where n is the number of pairs for which a clamping error Fᵢ could be determined.

38. The method as recited in claim 26,
wherein the scalar clamping error F between two descriptions of the object under measurement is determined as the maximum positive deviation of the scalar clamping errors Fᵢ
F=MAXIMUM(F₁, F₂, . . . Fₙ)
where n is the number of pairs for which a clamping error Fᵢ could be determined.

39. The method as recited in claim 26,
wherein the scalar clamping error F between two descriptions of the object under measurement is determined as the maximum negative deviation of the scalar clamping errors Fᵢ
F=MINIMUM(F₁, F₂, . . . , Fₙ)
where n is the number of pairs for which a clamping error Fᵢ could be determined.

40. The method as recited in claim 1,
wherein an interval halving is carried out as the exploratory method for modifying the transformation Tᵢₙᵢₜ and the subsequently resulting transformations.

41. The method as recited in claim 1,
wherein a gradient analysis is carried out as the exploratory method for modifying the transformation Tᵢₙᵢₜ and the subsequently resulting transformations.

42. The method as recited in claim 1,
wherein a Newtonian method for zero point determination is carried out as the exploratory method for modifying the transformation Tᵢₙᵢₜ and the subsequently resulting transformations.

43. The method as recited in claim 1,
wherein a Fourier analysis is carried out within the scope of the exploratory method for modifying the transformation Tᵢₙᵢₜ and the subsequently resulting transformations.

44. The method as recited in claim 1,
wherein a maximum number of modifications of the transformation is specified as termination criterion for the exploratory method.

45. The method as recited in claim 1,
wherein a value for the clamping error is specified as termination criterion for the exploratory method.

46. The method as recited in claim 1,
wherein the exploratory method is terminated when a predefined number of modifications of the transformation has not resulted in a reduction of the clamping error.
